(19) United States
(12) Patent Application Publication
(10) Pub. No.: US 2024/0101801 A1
(43) Pub. Date: Mar. 28, 2024

(54) FIBER COMPOSITE MATERIAL

(71) Applicant: NAN YA PLASTICS CORPORATION, TAIPEI (TW)

(72) Inventors: TE-CHAO LIAO, TAIPEI (TW); HAN-CHING HSU, TAIPEI (TW); CHUN-LAI CHEN, TAIPEI (TW)

(21) Appl. No.: 18/071,584

(22) Filed: Nov. 29, 2022

(30) Foreign Application Priority Data
Sep. 27, 2022 (TW) 111136441

(51) Int. Cl. C08L 23/12

(52) U.S. Cl. CPC C08L 23/12; C08L 2205/025; C08L 2205/035; C08L 2310/00

(57) ABSTRACT

A fiber composite material is provided. The fiber composite material includes 40 phr to 65 phr of a polypropylene resin, 30 phr to 60 phr of a long glass fiber, 0.5 phr to 5 phr of a black masterbatch, and 0.5 phr to 10 phr of a compatibilizer. The black masterbatch contains carbon black having a basic active group on a surface of the carbon black. The compatibilizer is grafted with maleic anhydride.

### CROSS-REFERENCE TO RELATED PATENT APPLICATION

This application claims the benefit of priority to Taiwan Patent Application No. 111136441, filed on Sep. 27, 2022. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a fiber composite material, and more particularly to a fiber composite material having good physical strength.

### BACKGROUND OF THE DISCLOSURE

Polypropylene is a crystalline polymer having an orderly structure, and has characteristics of easy processing, high impact resistance, flexibility, and good electrical insulation. However, due to limited stiffness strength and heat resistance of polypropylene, certain inorganic substances are added thereto for strengthening the polypropylene.

For example, glass fiber is added to polypropylene to produce a fiber composite material having better stiffness strength and heat resistance than polypropylene. Therefore, the fiber composite material can have a wider range of application in different fields.

In addition, in order to meet product requirements, pigments (such as carbon black) are usually added to the fiber composite material so that the fiber composite material can have different colors. However, when a fiber composite material has the same glass fiber content, the addition of the pigments reduces a physical strength (such as tensile strength, elongation, flexural strength, and impact strength) of the fiber composite material, such that the fiber composite material is inapplicable for certain products.

Therefore, how to increase the physical strength of the fiber composite material by improving the components or ratios of the fiber composite material to overcome the defect that the physical strength of the fiber composite material is decreased after pigments are added to the fiber composite material has become one of the important issues to be addressed in this industry.

### SUMMARY OF THE DISCLOSURE

In response to the above-referenced technical inadequacies, the present disclosure provides a fiber composite material.

In one aspect, the present disclosure provides a fiber composite material. The fiber composite material includes the following components: 40 phr to 65 phr of a polypropylene resin, 30 phr to 60 phr of a long glass fiber, 0.5 phr to 5 phr of a black masterbatch, and 0.5 phr to 10 phr of a compatibilizer. The black masterbatch contains carbon black having a basic active group on a surface of the carbon black. The compatibilizer is grafted with maleic anhydride.

In certain embodiments, a pH value of the carbon black ranges from 8 to 10.

In certain embodiments, a particle size of the carbon black ranges from 12 nm to 20 nm.

In certain embodiments, a maleic anhydride grafting ratio of the compatibilizer ranges from 0.5% to 1.3%.

In certain embodiments, the compatibilizer is a polyolefin elastomer grafted with maleic anhydride or polypropylene grafted with maleic anhydride.

In certain embodiments, the fiber composite material further includes 0.5 phr to 10 phr of a toughener that is a polyolefin elastomer.

In certain embodiments, the toughener is a polyolefin elastomer formed by copolymerization of α-olefin, and the α-olefin includes ethylene, 1-propene, 1-butene, 1-hexene, or 1-octene.

In certain embodiments, a weight ratio of the toughener to the compatibilizer ranges from 1:1 to 4:1.

In certain embodiments, a material of the black masterbatch includes polyethylene and the carbon black, and a content of the carbon black in the black masterbatch ranges from 20 wt % to 45 wt %.

In certain embodiments, a tensile strength of the fiber composite material ranges from 129 MPa to 145 MPa, an elongation of the fiber composite material ranges from 3.25% to 3.6%, a flexural strength of the fiber composite material ranges from 185 MPa to 196 MPa, a flexural modulus of the fiber composite material ranges from 6600 MPa to 7100 MPa, and an impact strength of the fiber composite material ranges from 20 KJ/m² to 28 KJ/m².

In certain embodiments, a content of the polypropylene resin ranges from 55 phr to 65 phr, a content of the black masterbatch ranges from 0.8 phr to 1.5 phr, and a content of the compatibilizer ranges from 0.5 phr to 3 phr.

In certain embodiments, a content of the polypropylene resin ranges from 45 phr to 55 phr, a content of the black masterbatch ranges from 0.8 phr to 1.5 phr, and a content of the compatibilizer ranges from 0.5 phr to 3 phr. in which fiber composite material further includes 2 phr to 6 phr of a toughener.

In certain embodiments, a content of the polypropylene resin ranges from 45 phr to 55 phr, a content of the black masterbatch ranges from 0.4 phr to 1.5 phr, and a content of the compatibilizer ranges from 1 phr to 4 phr; in which the fiber composite material further includes 2 phr to 6 phr of a toughener.

One of the beneficial effects of the present disclosure is that, for the fiber composite material provided by the present disclosure, by virtue of “the black masterbatch containing carbon black having a basic active group on a surface of the carbon black,” and “the compatibilizer being grafted with maleic anhydride,” the tensile strength, elongation, flexural strength, and impact strength of the fiber composite material can be improved.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of an apparatus for manufacturing a fiber composite material according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

To address the issue of a physical strength of a fiber composite material being decreased after a pigment is added to the fiber composite material, in the present disclosure, the contents of components in a fiber composite material are controlled for improving a physical strength, such as tensile strength, flexural strength, and impact strength, of the fiber composite material.

The fiber composite material of the present disclosure includes the following components: 40 phr to 65 phr of a polypropylene resin, 30 phr to 60 phr of a long glass fiber, 0.5 phr to 5 phr of a black masterbatch, 0.5 phr to 10 phr of a toughener, 0.5 phr to 10 phr of a compatibilizer, 0.1 to 0.6 phr of an antioxidant, and 0.1 to 2 phr of a slip agent.

The polypropylene resin includes 50 phr or more of polypropylene. The polypropylene mentioned herein may be a propylene homopolymer or a propylene copolymer. Moreover, the polypropylene resin may further include other types of thermoplastic resins, for example, polyethylene, but the present disclosure is not limited thereto. In one exemplary embodiment, the polypropylene resin has a melt index of from 25 g/10 min to 120 g/10 min at 230° C. In other embodiments, a content of the polypropylene resin in the fiber composite material may be 45 phr, 50 phr, 55 phr, or 60 phr.

Addition of the long glass fiber can improve a stiffness strength and heat resistance of the fiber composite material. In other embodiments, a content of the long glass fiber in the fiber composite material may be 35 phr, 40 phr, 45 phr, 50 phr, or 55 phr. Specifically, a length of the long glass fiber ranges from 7 mm to 13 mm. In other embodiments, the length of the long glass fiber may be 8 mm, 9 mm, 10 mm, 11 mm, or 12 mm.

A material of the black masterbatch includes polyethylene and the carbon black. The polyethylene mentioned herein may be an ethylene homopolymer or an ethylene copolymer. The black masterbatch includes 20 wt % to 45 wt % of the carbon black, and preferably, the black masterbatch includes 25 wt % to 35 wt % of the carbon black. In other embodiments, a content of the black masterbatch in the fiber composite material is 25 wt %, 30 wt %, 35 wt %, or 40 wt %.

In the present disclosure, the carbon black undergoes a surface treatment, so that the carbon black has a basic active group on a surface of the carbon black, and the basic active group may be hydroxyl (—OH) or amino (—NH₂) group. Therefore, the carbon black is well compatible with other components (specifically, the polypropylene resin and the long glass fiber), thereby improving the physical strength of the fiber composite material.

To quantify the basic active group of the carbon black, 0.5 g of the carbon black is added to 100 ml of distilled water to form carbon black solution. The carbon black solution is heated at 80° C. for 15 minutes, and a pH value of the carbon black solution is measured with an acid-base meter after the carbon black solution is cooled to room temperature. It can be known from the results that the pH value of the carbon black solution ranges from 8 to 10, in other words, in the present disclosure, the pH value of the carbon black ranges from 8 to 10. In other embodiments, the pH value of the carbon black may be 8.2, 8.4, 8.6, 8.8, 9.0, 9.2, 9.4, 9.6, or 9.8.

Particle sizes of commercially available carbon blacks range from 35 nm to 100 nm. However, in the present disclosure, carbon black with a smaller particle size (less than 30 nm) is particularly selected to improve the physical strength of the fiber composite material.

In one exemplary embodiment, a particle size of the carbon black ranges from 12 nm to 20 nm. When the particle size of the carbon black falls within this range, the carbon black can be uniformly dispersed in the fiber composite material, and addition of the carbon black does not negatively affect the compatibility of other components in the fiber composite material, so that the physical strength of the fiber composite material can be improved. In other embodiments, the particle size of the carbon black may be 13 nm, 15 nm, 17 nm, or 19 nm.

A content of the black masterbatch in the fiber composite material may be 1 phr, 2 phr, 3 phr, or 4 phr. After addition of the black masterbatch, a weight proportion of the carbon black in the overall fiber composite material ranges from 0.1 wt % to 2 wt %. When a content of the carbon black is too high, the physical strength of the fiber composite material is negatively affected. In other embodiments, a weight ratio of the carbon black in the overall fiber composite material is 0.3 wt %, 0.5 wt %, 0.7 wt %, 0.9 wt %, 1.1 wt %, 1.3 wt %, 1.5 wt %, 1.7 wt %, or 1.9 wt %.

The toughener is a polyolefin elastomer. Addition of the toughener can improve a flexural strength and impact strength of the fiber composite material. Specifically, the toughener is a polyolefin elastomer formed by copolymerization of α-olefin, and the α-olefin includes ethylene, 1-propene, 1-butene, 1-hexene, or 1-octene. In the present disclosure, the toughener may be an ethylene propylene rubber (EPM), an ethylene propylene diene monomer (EPDM), an ethylene/α-olefin random copolymer, or an ethylene/α-olefin block copolymer. However, the present disclosure is not limited thereto.

In one exemplary embodiment, the toughener has a density of from 0.84 g/cm³ to 0.88 g/cm³. The toughener has a melt index of from 18 g/10 min to 22 g/10 min at 230° C. By controlling the melt index of the toughener, the fiber composite material can be maintained to have certain fluidity, such that a fiber composite material containing long glass fibers can be suitably manufactured. Furthermore, 10 wt % to 20 wt % of vinyl is included in the toughener to improve a toughness of the fiber composite material. In other embodiments, a content of the toughener in the fiber composite material is 2 phr, 4 phr, 6 phr, 8 phr, or 10 phr.

In the present disclosure, the compatibilizer is grafted with maleic anhydride. A part of the compatibilizer grafted with maleic anhydride can be bonded with the long glass fiber, and a part of the compatibilizer not grafted with maleic anhydride can be mixed with the polypropylene resin. Accordingly, addition of the compatibilizer can improve compatibility between the components (particularly, the polypropylene resin and the long glass fiber), thereby improving the physical strength of the fiber composite material.

Generally, the compatibilizer can be divided into a compatibilizer with a low maleic anhydride grafting ratio (the grafting ratio is less than 1.5%) and a compatibilizer with a high maleic anhydride grafting ratio (the grafting ratio is more than 1.5%). In order to prevent an excessive amount of the compatibilizer from causing a decrease of the tensile strength and flexural strength of the fiber composite material, when a compatibilizer with a high maleic anhydride grafting ratio is used, an addition amount of the compatibilizer that is added ranges from 1 phr to 1.5 phr, and when a compatibilizer with a low maleic anhydride grafting ratio is used, an addition amount of the compatibilizer that is added ranges from 1.5 phr to 2.5 phr.

In an exemplary embodiment, a maleic anhydride grafting ratio of the compatibilizer ranges from 0.5% to 1.3%. In other embodiments, the maleic anhydride grafting ratio of the compatibilizer may be 0.6%, 0.7%, 0.8%, 0.9%, 1.0%, 1.1%, or 1.2%. In the present disclosure, the compatibilizer may be a polyolefin elastomer grafted with maleic anhydride (POE-g-MAH) or polypropylene grafted with maleic anhydride (PP-g-MAH). In one exemplary embodiment, the compatibilizer is polypropylene grafted with maleic anhydride, and has better compatibility with the polypropylene resin.

In one exemplary embodiment, the compatibilizer has a density of from 0.85 g/cm³ to 0.95 g/cm³. The compatibilizer has a melt index of from 420 g/10 min to 440 g/10 min at 230° C. By controlling the melt index of the compatibilizer, the fiber composite material can be maintained to have a certain fluidity, such that a fiber composite material containing long glass fibers can be suitably manufactured. In other embodiments, a content of the compatibilizer in the fiber composite material is 2 phr, 4 phr, 6 phr, 8 phr, or 10 phr. When an addition amount of the compatibilizer is too high (more than 10 phr), a tensile strength and flexural strength of the fiber composite material may be degraded.

It is worth noting that, in the present disclosure, an addition weight ratio of the toughener to the compatibilizer is particularly regulated, so as to improve compatibility between the materials. In the present disclosure, a weight ratio of the toughener to the compatibilizer ranges from 1:1 to 4:1. In one exemplary embodiment, a weight of the toughener is greater than a weight of the compatibilizer Preferably, a weight ratio of the toughener to the compatibilizer ranges from 1.2:1 to 2.5:1. More preferably, a weight ratio of the toughener to the compatibilizer ranges from 1.4:1 to 2:1.

Addition of an antioxidant can improve an oxidation resistance of the fiber composite material, so as to prolong a service life of the fiber composite material. For example, the antioxidant may be a polyphenol antioxidant, but the present disclosure is not limited thereto.

Addition of the slip agent can improve the tactile sensation of the fiber composite material, so that the fiber composite material can be applied to various products. For example, the slip agent may be polyethylene wax, but the present disclosure is not limited thereto.

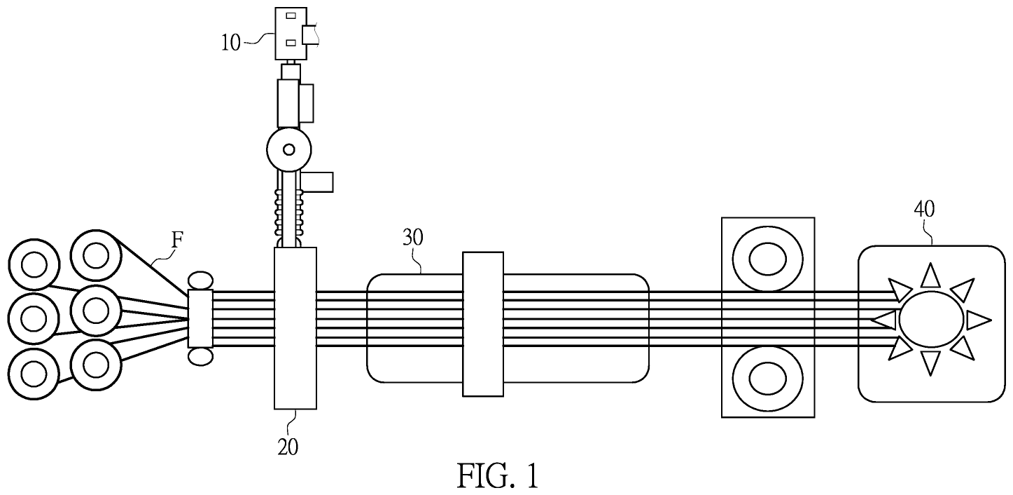

Referring to FIG. 1, FIG. 1 is a schematic diagram of an apparatus for manufacturing a fiber composite material according to the present disclosure. To prepare the fiber composite material, the foregoing polypropylene resin, black masterbatch, toughener, compatibilizer, antioxidant, and slip agent are fed into a twin-screw extruder 10. The twin-screw extruder 10 is set at a temperature of from 220° C. to 300° C. and a screw speed of 250 rpm. Therefore, the foregoing raw materials can be mixed uniformly in a molten state to form a plastic melt, and the plastic melt is transferred to an immersion device 20.

Rolls of continuous long glass fibers F are preheated at 120° C., and transferred to the immersion device 20 after yarn spreading. After being immersed, a surface of the long glass fiber F is completely covered by the plastic melt. The long glass fiber F is passed through a cooling and shaping device 30 and then transferred to a pelletizer 40. Fiber composite pellets are produced through the pelletizer 40, and can be used for manufacturing the fiber composite material.

To prove that the fiber composite material of the present disclosure has good physical strength, fiber composite materials of Examples 1 to 4 and Comparative Examples 1 and 2 are prepared according to the foregoing preparation method. Specific components of the fiber composite materials of Examples 1 to 4 and Comparative Examples 1 and 2 are listed in Table 1. The main difference between Examples 1 to 4 and Comparative Examples 1 to 2 is that the carbon black used in Examples 1 to 4 is surface-treated to have a basic active group, and the carbon black used in Comparative Examples 1 and 2 is surface-treated to have an acidic active group.

After the fiber composite materials are prepared, the fiber composite materials of Examples 1 to 4 and Comparative Examples 1 and 2 are tested for a tensile strength, elongation, flexural strength, flexural modulus, impact strength, and spiral fluidity. Test results are listed in Table 1.

In Table 1, the compatibilizer is a polypropylene elastomer grafted with maleic anhydride. The toughener is a polyolefin elastomer. The black masterbatch (acidic active group) refers to carbon black in the black masterbatch having an acidic active group on a surface of the carbon black. The black masterbatch (basic active group) refers to carbon black in the black masterbatch having a basic active group on a surface of the carbon black. The antioxidant is a polyphenol antioxidant. The slip agent is polyethylene wax.

TABLE 1

| | | | | | | Comparative | Comparative |
|---|---|---|---|---|---|---|---|
| | | Example | Example | Example | Example | Example | Example |
| Component (phr) | | 1 | 2 | 3 | 4 | 1 | 2 |
| Polypropylene resin | | 57.25 | 54.25 | 54 | 52.75 | 57.25 | 54.25 |
| Compatibilizer | | 1.5 | 1.5 | 2 | 2.5 | 1.5 | 1.5 |
| Toughener | | — | 3 | 3 | 4 | — | 3 |
| Black masterbatch | | — | — | — | — | 1 | 1 |
| (acidic active group) | | | | | | | |
| Black masterbatch | | 1 | 1 | 0.75 | 0.5 | — | — |
| (basic active group) | | | | | | | |
| Antioxidant | | 0.15 | 0.15 | 0.15 | 0.15 | 0.15 | 0.15 |
| Slip agent | | 0.1 | 0.1 | 0.1 | 0.1 | 0.1 | 0.1 |
| Long glass fiber | | 40 | 40 | 40 | 40 | 40 | 40 |
| Properties | Tensile | 141.5 | 129.8 | 138.3 | 134.6 | 128.7 | 129.4 |
| | strength | | | | | | |
| | (MPa) | | | | | | |
| | Elongation | 3.39 | 3.26 | 3.48 | 3.56 | 3.23 | 3.43 |
| | (%) | | | | | | |
| | Flexural | 186 | 194 | 189 | 189.1 | 178 | 176 |
| | strength | | | | | | |
| | (MPa) | | | | | | |
| | Flexural | 6877 | 6659 | 6624 | 6604 | 6958 | 6590 |
| | modulus | | | | | | |
| | (MPa) | | | | | | |
| | Impact | 20.02 | 23.64 | 24.5 | 27.32 | 18.0 | 22.6 |
| | strength | | | | | | |
| | (KJ/m²) | | | | | | |
| | Spiral | 92.5 | 89.3 | 88.83 | 87.67 | 93.67 | 96.67 |
| | fluidity | | | | | | |
| | (−) | | | | | | |

From the results in Table 1, it can be seen that in the present disclosure, by controlling the contents of components in the fiber composite material, the fiber composite material can have a tensile strength of from 129 MPa to 145 MPa, an elongation of from 3.25% to 3.6%, a flexural strength of from 185 MPa to 196 MPa, a flexural modulus of from 6600 MPa to 7100 MPa, and an impact strength of from 20 KJ/m² to 28 KJ/m².

From the results of Example 1 and Comparative Examples 1 and 2, it can be seen that when no toughener is added, the use of carbon black with a basic active group in the present disclosure can improve the tensile strength, elongation, flexural strength, and impact strength of the fiber composite material.

From the results of Example 2 and Comparative Example 2, it can be seen that when a toughener is added, the use of carbon black with a basic active group in the present disclosure can improve the tensile strength, flexural strength, and impact strength of the fiber composite material.

From Examples 2 to 4, it can be seen that when both a toughener and a compatibilizer are added, controlling a weight ratio of the toughener to the compatibilizer to be from 1.4:1 to 2:1 in the present disclosure can further improve the flexural strength and impact strength of the fiber composite material.

According to the results of Example 1, when the components of the fiber composite material are controlled to include 55 phr to 65 phr of a polypropylene resin, 0.8 phr to 1.5 phr of a black masterbatch, and 0.5 phr to 3 phr of a compatibilizer, the tensile strength of the fiber composite material can be improved to be at 140 MPa or more.

According to the results of Example 2, when the components of the fiber composite material are controlled to include 45 phr to 55 phr of a polypropylene resin, 0.8 phr to 1.5 phr of a black masterbatch, 0.5 phr to 3 phr of a compatibilizer, and 2 phr to 6 phr of a toughener, the tensile strength of the fiber composite material can be improved to be at 190 MPa or more.

According to the results of Example 3, when the components of the fiber composite material are controlled to include 45 phr to 55 phr of a polypropylene resin, 0.8 phr to 1.5 phr of a black masterbatch, 1 phr to 4 phr of a compatibilizer, and 2 phr to 6 phr of a toughener, the impact strength of the fiber composite material can be increased to 24 KJ/m² or more.

### Beneficial Effects of the Embodiments

One of the beneficial effects of the present disclosure is that for the fiber composite material provided by the present disclosure, by virtue of “the black masterbatch containing carbon black having a basic active group on a surface of the carbon black,” and “the compatibilizer being grafted with maleic anhydride,” the tensile strength, elongation, flexural strength, and impact strength of the fiber composite material can be improved.

Furthermore, by virtue of “0.5 phr to 10 phr of a toughener being a polyolefin elastomer,” the fiber composite material can have better flexural strength and impact strength.

Moreover, by virtue of “a weight ratio of the toughener to the compatibilizer ranging from 1:1 to 4:1,” the fiber composite material can have better flexural strength and impact strength.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A fiber composite material, comprising:
40 phr to 65 phr of a polypropylene resin;
30 phr to 60 phr of a long glass fiber;
0.5 phr to 5 phr of a black masterbatch, wherein the black masterbatch contains carbon black having a basic active group on a surface of the carbon black; and
0.5 phr to 10 phr of a compatibilizer, wherein the compatibilizer is grafted with maleic anhydride.

2. The fiber composite material according to claim 1, wherein a pH value of the carbon black ranges from 8 to 10.

3. The fiber composite material according to claim 1, wherein a particle size of the carbon black ranges from 12 nm to 20 nm.

4. The fiber composite material according to claim 1, wherein a maleic anhydride grafting ratio of the compatibilizer ranges from 0.5% to 1.3%.

5. The fiber composite material according to claim 4, wherein the compatibilizer is a polyolefin elastomer grafted with maleic anhydride or polypropylene grafted with maleic anhydride.

6. The fiber composite material according to claim 1, further comprising: 0.5 phr to 10 phr of a toughener that is a polyolefin elastomer.

7. The fiber composite material according to claim 6, wherein the toughener is a polyolefin elastomer formed by copolymerization of α-olefin, and the α-olefin includes ethylene, 1-propene, 1-butene, 1-hexene, or 1-octene.

8. The fiber composite material according to claim 6, wherein a weight ratio of the toughener to the compatibilizer ranges from 1:1 to 4:1.

9. The fiber composite material according to claim 1, wherein a material of the black masterbatch includes polyethylene and the carbon black, and a content of the carbon black in the black masterbatch ranges from 20 wt % to 45 wt %.

10. The fiber composite material according to claim 1, wherein a tensile strength of the fiber composite material ranges from 129 MPa to 145 MPa, an elongation of the fiber composite material ranges from 3.25% to 3.6%, a flexural strength of the fiber composite material ranges from 185 MPa to 196 MPa, a flexural modulus of the fiber composite material ranges from 6600 MPa to 7100 MPa, and an impact strength of the fiber composite material ranges from 20 KJ/m² to 28 KJ/m².

11. The fiber composite material according to claim 1, wherein a content of the polypropylene resin ranges from 55 phr to 65 phr, a content of the black masterbatch ranges from 0.8 phr to 1.5 phr, and a content of the compatibilizer ranges from 0.5 phr to 3 phr.

12. The fiber composite material according to claim 1, wherein a content of the polypropylene resin ranges from 45 phr to 55 phr, a content of the black masterbatch ranges from 0.8 phr to 1.5 phr, and a content of the compatibilizer ranges from 0.5 phr to 3 phr; wherein the fiber composite material further comprises 2 phr to 6 phr of a toughener.

13. The fiber composite material according to claim 1, wherein a content of the polypropylene resin ranges from 45 phr to 55 phr, a content of the black masterbatch ranges from 0.4 phr to 1.5 phr, and a content of the compatibilizer ranges from 1 phr to 4 phr; wherein the fiber composite material further comprises 2 phr to 6 phr of a toughener.
